(19) United States
(12) Patent Application Publication
(10) Pub. No.: US 2009/0237219 A1
(43) Pub. Date: Sep. 24, 2009

(54) SECURITY APPARATUS, SYSTEM AND METHOD OF USING SAME

(76) Inventors: Bradley M. BERLIN, Santa Cruz, CA (US); Margaret O. Nyswonger, Santa Cruz, CA (US)

Correspondence Address: BARNES & THORNBURG LLP, 750-17TH STREET NW, SUITE 900, WASHINGTON, DC, 20006-4675, US

(21) Appl. No.: 12/403,669

(22) Filed: Mar. 13, 2009

Related U.S. Application Data
(60) Provisional application No. 61/038,561, filed on Mar. 21, 2008.

(51) Int. Cl. H04Q 5/22

(52) U.S. Cl. 340/10.6; 340/10.1

(57) ABSTRACT

Methodologies and mechanisms are provided that enable implementation of a system and methodologies for detachment of a security tag (e.g., an identification tag) from an article only upon the sale of the article, wherein the identification data indicating the personnel detaching the security tag is logged in connection with data specific to the article sale transaction.

This application claims the benefit of priority to U.S. Provisional Patent Application No. 61/038,461 filed Mar. 21, 2008, which is incorporated herein by reference in its entirety.

The invention relates in general to product security tags and, more particularly, to a system and method for releasing a security tag, as specified in the independent claims.

### BACKGROUND OF THE INVENTION

The use of security tags (also known as anti-theft tags) has been conventionally effective at attempting to reduce or eliminate shoplifting of store inventory. Such tags use various wireless interrogation technologies, such as ElectroMagnetic (EM), Acousto-Magnetic (AM), Radio Frequency (RF), etc., and are attached to a store article and are interrogated as they pass through an interrogation site (e.g., a pair of field-emitting and signal receiving pedestals) usually located at the store exit.

If these tags are not removed from the article, or de-activated, before entering the interrogation site, they will set off an alarm at the interrogation site, thereby alerting store personnel to the theft. With particular regard to the wireless RF technology, the security tags may include a Radio Frequency IDentification (RFID) Integrated Circuit (IC) having a memory that includes data (e.g., product ID information such as a serial number, unique identification number, price, etc.) associated with the store article that the tag is attached to. When the security tag including the RFID IC passes by a reader, the RFID IC emits a signal that contains the data associated with the store article. Because this type of security tag emits such particularized data, this type of security tag is also referred to as an “identification tag.”

Such conventional tags have been particularly effective at eliminating “walk out” theft, wherein store products are removed from the store by shoppers, individuals browsing store products and the like.

Nevertheless, it should be understood that the vast majority of store inventory “shrinkage” occurs due to acts by store employees known as “sweethearting.” For example, a cashier may knowingly defeat the security tag by removing it or de-activating it and then not ring up the article for sale.

Also, where a valid sale of an article having a security tag attached thereto does occur, the security tag detachment stage usually occurs separate from the UPC barcode stage. Thus, the cashier may scan the UPC barcode on the article which rings up the sale; and detach a security tag to another article for later handoff to an accomplice.

Video surveillance solutions may be ineffective depending on the skill of the employee committing a theft.

Thus, there remains a need for preventing such “sweetheart” acts by employees by preventing the cashier from controlling the security tag removal stage.

### SUMMARY OF THE INVENTION

The following presents a simplified summary in order to provide a basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to the more detailed description below.

In accordance with at least one embodiment of the invention, methodologies and mechanisms are provided that enable implementation of a system and methodologies for detachment of a security tag (e.g., an identification tag) from an article only upon the sale of the article, wherein the identification data indicating the personnel detaching the security tag is logged in connection with data specific to the article sale transaction, as specified in the independent claims. This is achieved by a combination of features recited in each independent claim. Accordingly, dependent claims prescribe further detailed implementations of the present invention.

### BRIEF DESCRIPTION OF THE DRAWINGS

A more compete understanding of the present invention and the utility thereof may be acquired by referring to the following description in consideration of the accompanying drawings, in which like reference numbers indicate like features, and wherein:

FIG. 1 illustrates an environment 100 wherein various components may be utilized in accordance with at least one embodiment of the invention.

FIG. 2 illustrates various security system components provided in accordance with at least one embodiment of the invention.

FIG. 3 illustrates one example of various process operations that may be performed in accordance with at least one embodiment of the invention.

### DETAILED DESCRIPTION OF THE INVENTION

In the following description of various invention embodiments, reference is made to the accompanying drawings, which form a part hereof, and in which is shown, by way of illustration, various embodiments in which the invention may be practiced. It is to be understood that other embodiments may be utilized and structural and functional modifications may be made without departing from the scope and spirit of the present invention.

Moreover, it should be understood that various connections are set forth between elements in the following description; however, these connections in general, and, unless otherwise specified, may be either direct or indirect, either permanent or transitory, and either dedicated or shared, and that this specification is not intended to be limiting in this respect.

It should be understood that the term “security tag” as used throughout this disclosure includes any device which reflects electromagnetic energy for the purpose of identifying itself to a reader/interrogator and is not limited to only IC-based devices. Thus, any Electronic Article Surveillance (EAS) tag, such as RF, EM or AM, would be included. As a result, any RFID “reader” used in the EAS frequency ranges may comprise a transmitter/receiver pair tuned to one or more EAS frequencies.

As explained above, employee theft of inventory can be implemented using a co-conspirator (often a customer) acting in collusion with the employee or take place unbeknownst to a customer. For example, presuming an employee desires to steal an article “A,” he may remove the article from a rack or shelf and place it in a location near a Point of Sale (POS) machine such as a cash register. Subsequently, a customer may arrive with several security tagged articles to purchase.

Conventionally, the employee, acting as a cashier, may remove the security tags from the customer's articles, pull article “A” from its location (e.g., a sales counter), removes a security tag from article “A,” and place article “A” back below the counter. As a result, the customer's valid and appropriate sale transaction is completed. However, article “A” is now untagged, and even with video surveillance at the POS location, the action of the cashier may go unnoticed.

Subsequently, the employee may pass the article “A” to an accomplice (who may or may not have been the “customer” for whom the sales transaction was processed) who leaves through a customer exit. Thus, when the employee leaves through the employee exit, and is searched, no contraband articles are found.

Other theft scenarios that circumvent conventional security tag technology as also foreseeable. However, the unifying issue regarding these scenarios is that there is no conventional mechanism for effectively auditing the removal of security tags or ensuring that removed security tags correspond to the articles that are the subject of a POS transaction.

As a result, in accordance with at least one embodiment of the invention, a security tag removal system is integrated with one or more POS systems, employee badging and store security systems in a complete security and internal (employee) theft prevention solution.

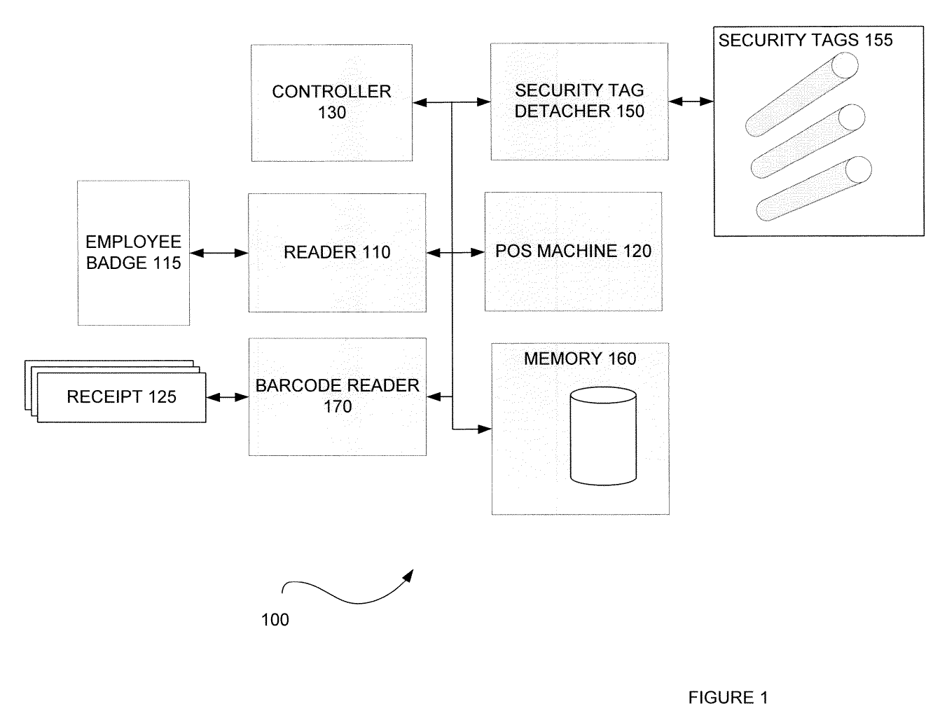

FIG. 1 illustrates an environment 100 wherein various components may be utilized in accordance with at least one embodiment of the invention. As illustrated in FIG. 1, may include a reader (e.g., an RFID reader) 110 located at the point of sale that reads the security tag to identify the article being purchased; a Point Of Sale (POS) machine 120 (e.g., a cash register and/or a credit/debit card reader, any type of money/currency transfer machine for supporting the purchase of the article, etc. coupled to and in communication with the reader credit/debit card reader), that verifies if the read article is ready for sale.

The reader 110 (e.g., RFID card reader) which can read employee information from an RFID employee badge 115. The reader 110 may be implemented using conventional technology implemented in, for example, off the shelf components.

The POS machine 120 may include, for example, a cash register a credit/debit card reader, any type of money/currency transfer machine for supporting the purchase of the article, etc. When the article 105 is first delivered to the store, the article 105 identification, and other sales data related to that article 105, may be stored in a memory in the POS machine 120, in memory 160 or any other memory accessible as part of a sales transaction for the article and/or like articles.

Thus, when a customer arrives at the POS machine 120, the cashier positions the security tag 155 and article 105 so that the reader 110 can obtain article specific information (e.g., product identifier, UPC number, status information, etc.) from the security tag 155 (and/or article 105) and pass that information to the POS machine 120. If the POS machine 120 determines that the article is a valid article ready for sale, as will be discussed in detail later, the POS machine 120 rings up the sale provides authorization to the tag removal device 150 to release the security tag 155 from the article 105. Upon release, the cashier can retrieve the security tag 155 for the store's re-use on another article. If, on the other hand, the POS machine 120 determines that the sale is invalid, the tag removal device 150 does not operate to release the security tag 155 and the sale of that article is terminated, with the security tag 155 remaining attached to the article 105.

In accordance with at least one embodiment of the invention, a tag removal device 150, is provided under the control of a controller 130, which controls and integrates the operation of the tag removal device 150 in combination with the other components utilized in environment 100. The controller 130 may be implemented using conventional and/or standard hardware but may require custom coding and interface development to ensure that the controller 130 can interface with and control the other components included in environment 100.

Also included in the environment 100 is memory 160 coupled to and in communication with the tag removal device 150. In accordance with at least one embodiment of the invention, the tag removal device 150 is authorized to release a security tag from an article only if the POS machine 120 verifies that the read article is ready for sale. As part of issuing the authorization to release the security tag, the memory 160, which includes one or more databases, stores the identity of the personnel initiating the transaction for sale of the tagged article. In accordance with at least one embodiment of the invention, the memory 160 may also store data indicating the nature of the sold article (e.g., type of product) or data otherwise identifying the transaction article (e.g., allowing cross referencing with inventory or sales data).

The memory 160 may be configured to store various data associated with sales transactions to enable sales transaction auditing for potential theft. Therefore, the memory may include one or more data entries associated with a sales transaction. Such a data entry may include, for example, the employee/user ID associated with the transaction, the date/time that the employee logged into the system, the number of security tags removed, the number of articles on the POS receipt (and possibly related information), date/time logged out, etc.

Additionally, to the extent that at least one embodiment of the invention processes tags 155 that provide some indication of the nature or identity of the article to which they are affixed, the tag removal device 150 may be configured to interrogate the tag as part of the tag removal process and transmit information provided by the interrogation to the memory 160 for storage in a data entry associated sales transaction.

The tag removal device 150 may be implemented with a unique form factor permitting the removal of specific tags 155, which can be locked from use or unlocked for use through a mechanical or electrical interface and which may be configured to send out a “count” signal to the controller 130.

Further, a barcode reader 170 may be included, which may be configured to read data encoded on receipts 125 produced by the POS machine 120. The barcode reader 170 may be implemented using conventional technology that may be included in an off the shelf component. However, specialized software may be necessary to read the barcode to determine, for example, the number of articles to be processed by the tag removal device 150.

As will be discussed in detail later, the tag removal device 150 of system 100 cannot release a tag 155 from the article 105 by an individual except following the POS machine 120 verifying that the article 105 is ready for sale. As a result, the cashier, or any other store employee, is unable to manually remove the security tag 155 from the article 105, thereby preventing “sweethearting” or any other type of employee theft. In addition, where sales information of the article 105 is scanned at the POS machine 120, the system 100 may improve processing efficiency of sales transactions by combining the scanning of an article 105 with the release of the security tag, while recording various pieces of information to enable auditing of tag removal/transaction processing. Therefore, in accordance with at least one embodiment of the invention the processing of the article 105 through the POS machine 120 may trigger both the recordation of related data and the release of a security tag from the article 105 scanned.

Accordingly, it should be understood that, as part of the processing of the article 105 through the POS machine 120, data may be obtained from memory 160 including an inventory database that indicates an identity of a particular security tag 155 to be removed. Therefore, it should be appreciated that, in accordance with at least one embodiment of the invention, each security tag 155 may be configured to be uniquely identified and associated with the article 105 to which it is affixed in an inventory database.

By way of example only, the security tag 155 used with the tag removal device 150 may be a hard tag. In the EAS industry, a “hard tag”, refers to a re-usable tag which is intended to be removed from an article 105 (merchandise) at the POS to be re-used on other merchandise. Hard tags typically have an injection-molded outer casing. This type of tag is typically found in the apparel industry.

As is conventionally known, security tags 155 may require the use of an IC that emits an identification code that can be detected by the reader 110 when the security tag 155 is positioned adjacent the reader antenna or passes through the interrogation pedestals. This can be accomplished using an RFID IC that forms a part of the resonant circuit or antenna. Thus, when the security tag 155 is positioned adjacent the reader antenna, or passes through the interrogation pedestals, the security tag 155 is subjected to transmitter signal, and the resonant circuit or antenna will respond to the particular interrogation signal frequency to which the resonant circuit/antenna is tuned, thereby emitting the signal containing the data associated with the store article 105.

Further, in accordance with at least one embodiment of the invention, the RFID IC may comprise a memory that contains data (e.g., identification code, status code, etc.) related to the article 105 to which the security tag 155 is attached. Thus, as is conventionally understood, when the security tag 155 is subjected to an interrogation signal from the antenna of reader 110, at a tuned frequency of the tag's resonant circuit/antenna, the resonant circuit/antenna temporarily powers the RFID IC and a response signal is transmitted back to the reader 110 comprising that article data. Such tags are known as passive security tags because the RFID IC is powered only by the signal received as opposed to having an on-board battery in the security tag 155 itself.

However, it should be understood that it is within the broadest scope of the present invention to include active security tags also, i.e., security tags that include an on-board power supply such as a battery(ies).

As should be understood by one of ordinary skill in the art, in order for the system to be effective, security tags must be configured in such a way that they can be removed only by a specific set of devices.

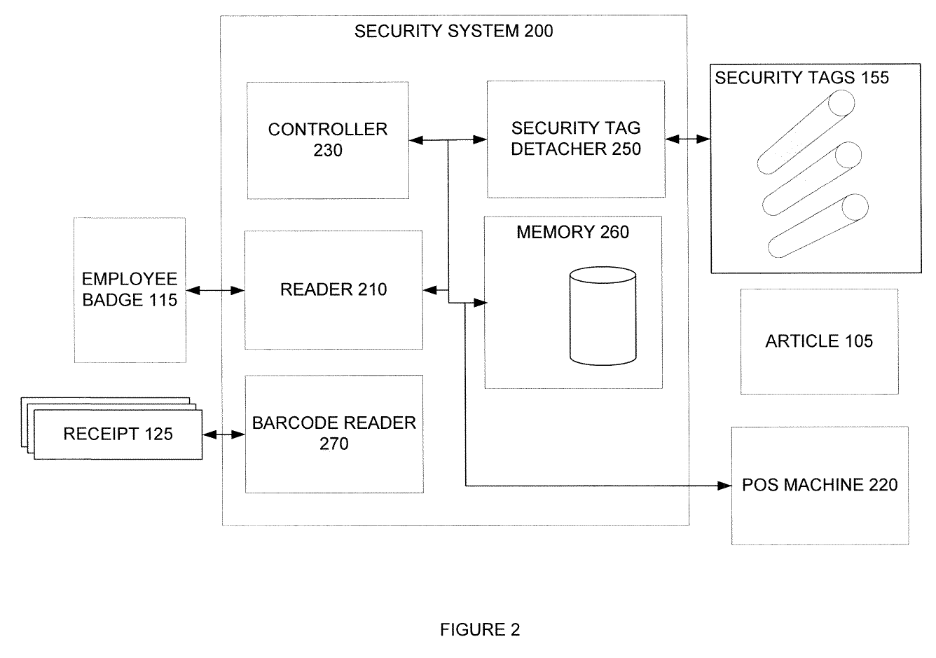

As illustrated in FIG. 2, a security system 200 designed in accordance with at least one embodiment of the invention is provided. As shown in FIG. 2, the system 200 may include a tag removal device 250, a reader 210 (e.g., an RFID reader, including an RFID antenna), a controller 230, a memory 260 and a barcode reader 270. The tag removal device 250, reader 210 and barcode reader 270 may be located along with a POS machine 220 at a store POS; the memory 260 may be collocated with the other components or located remotely from the POS.

The reader 210 may be located at a sufficient distance from the components of the tag removal device 250 so as not to disrupt the operation of the reader electronics. The reader 210 is coupled to the memory 260 which permits the reader 210 to transmit article IDentification (ID)/sales information to the memory 260. The memory 260 may also be coupled to the POS machine 220.

The tag removal device 250 may be implemented as is conventionally understood in the art of security tag design and use. For example, the tag removal device 250 may be configured to include one or more permanent and/or electromagnets displaceable by command of one or more motor controllers so as to be moved into close proximity to one or more parts of a security tag so as to generate the requisite magnetic field to release the security tag 155.

Further, the tag removal device 150 may be implemented using various types and/or components that are commercially available provided that security tags may not be removed using tag removal devices other than those that also require printing of a barcoded receipt, which indicates the number of tagged articles sold and requires that the cashier read the barcoded receipt using a bar code reader, which records the number of articles shown on the sales receipt compared to the number of articles which had tags removed.

Following recordation of the number of articles that require tags to be removed (and/or the number of articles included in the sales transaction), the security tag 155 is unlocked (e.g., enabled to remove a number of security tags 155 corresponding to the number of articles included in the transaction that require processing. It should be appreciated that, the barcode receipt may include data indicating the total number of items included in the transaction and/or a number of items included in the transaction that require processing by the tag removal device 250. Such information may included in the barcode read on the receipt or accessible in memory 260 (or some other memory) available to the controller 230 that controls operation of the tag removal device 150.

Moreover, in accordance with at least one embodiment of the invention, wherein tags 155 have specified identification data that provides some indication of the article to which the tags are affixed, the controller 230 may cooperate with the tag removal device 250, the memory 260 and/or the POS machine 220 to confirm that the security tags removed from the articles correspond to the security tags that should be processed by the tag removal device 250 based on the articles processed by the POS machine 220. Thus, in such an implementation, another mechanism may be provided to ensure that cashiers are not improperly using the tag removal device 250 to process articles other than those involved in a sales transaction.

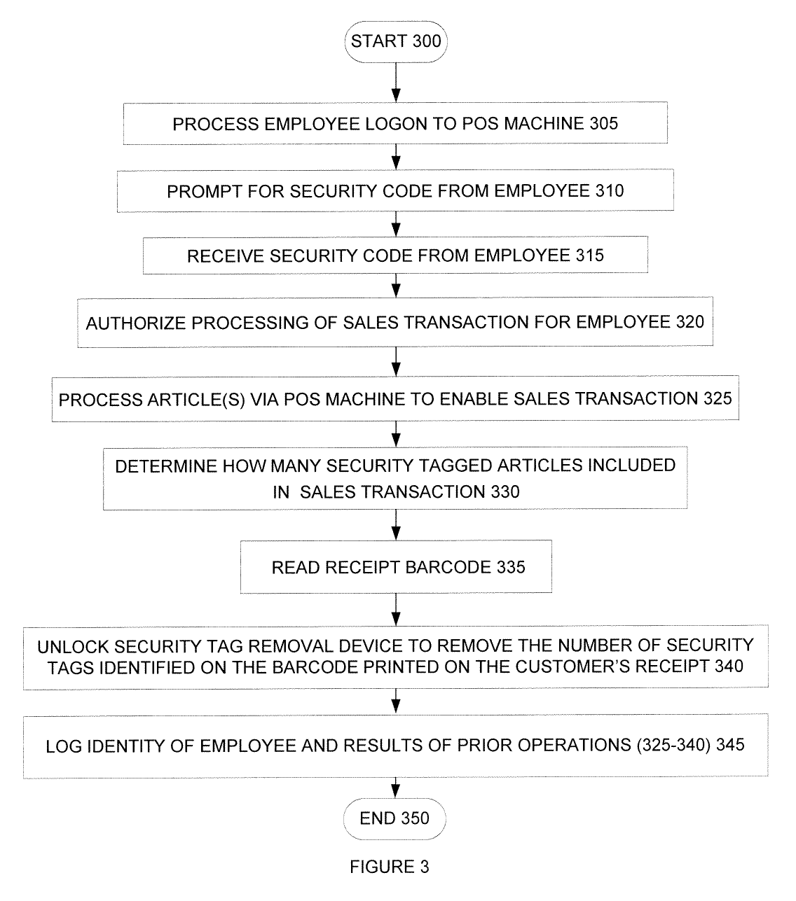

FIG. 3 illustrates one example of various process operations that may be performed in accordance with at least one embodiment of the invention.

As illustrated in FIG. 3, processing of an article for sale as part of a sales transaction may be performed. Processing operations may begin at 300, when a customer arrives at POS terminal with articles tagged by security tags. At 305, the cashier “logs” into the tag removal system using the cashier's employee ID (e.g., via for example, reading of the cashier's employee ID card). Control then proceeds to 310 at which the cashier may be prompted to enter some type of security code via, for example, a numeric keypad (which may also be provided to enable entry of the user's ID via manual login if there is a problem reading the employee ID card). Control then proceeds to 315, at which the code is received from the cashier and control proceeds to 320, at which the cashier is authorized to process a sales transaction.

Control then proceeds to 325, at which the article(s) is processed via the POS machine to enable the sales transaction. Control then proceeds to 330, at which determination is made regarding how many security tagged articles are included in the sales transaction. Data indicating the number of security tagged articles is then included in a barcode (or other tamper resistant mechanism) printed on the customer's sales transaction receipt. Control then proceeds to 335, at which the barcode is read by, for example, a bar code reader coupled to a security tag removal device. Control then proceeds to 340, at which the security tag removal device is unlocked or enabled to remove the number of security tags identified on the barcode printed on the customer's receipt. Control then proceeds to 345 at which various data associated with a transaction are stored in memory, including the employee/user ID associated with the transaction, the date/time that the employee logged into the system, the number of articles (tagged and/or untagged) processed as part of the transaction, the security tags removed, the number of articles on the POS receipt (and possibly related information), date/time logged out, etc. Control then proceeds to 350 at which operations performed in association with this particular transaction end.

It should be understood that, although FIG. 3 illustrates a serial and repetitive set of operations performed in association with a plurality of articles to be processed by a POS system, it is possible that operations may be performed for a plurality of articles to be purchased prior to any or all of the corresponding article security tags being removed. Therefore, the order of the processing operations performed for a plurality of articles is not required to be in any particular order provided that there is some way of determining the number of security tagged items to be removed in connection with a sales transaction, the number of security tagged items actually removed in connection with the transaction and the personnel performing the transaction. Therefore, it should be understood that articles may be processed and corresponding security tags removed in a serial manner rather than processing all articles through a POS system and then removing all corresponding security tags.

It should be further understood that, in accordance with at least one embodiment of the invention, the operations performed in FIG. 3 may include and culminate in the cashier being simultaneously “logged out” of the tag removal system, whereby the security tag removal device is “locked” until cashier identification and security are input to ensure that the system accurately identifies the cashier or personnel processing article sales transactions.

As a result of the operations performed in FIG. 3, various data associated with a transaction including the employee/user ID associated with the transaction, the date/time that the employee logged into the system, the number of security tags removed, the number of articles on the POS receipt (and possibly related information), date/time logged out, etc.

With this information, any discrepancy between the number of tags removed and the number of articles on the receipt may indicate a need to perform additional investigation. It should be appreciated that, in some situations, delayed investigation may be acceptable; however, “real time” notification of discrepancies to store security may be implemented as a part of the system capability.

Further, it should be understood that, in accordance with at least one embodiment of the invention, the authorization provided to the tag removal device may be article specific. Therefore, the only tag permitted to be removed may be the tag associated with the article identified in the POS transaction. Such an implementation may have particular utility when an employee is attempting to unlock an article-specific security tag associated with a more expensive article when processing a less expensive article via a store's POS system. Therefore, in accordance with at least one embodiment of the invention, operations may be performed to identify the security tag corresponding to an identified article is performed, e.g., by accessing one or more databases to identify the tag ID corresponding to the identified article.

RF tagging systems are well known in the art and depend on the existence of a single resonant circuit in a detection field or zone utilized as an anti-theft type apparatus. Essentially, if an article having a single resonant frequency tag passes through a detection zone, an alarm is generated which indicates the unauthorized presence of store goods in the detection zone. Such resonant circuits have been constructed in accordance with standard printed circuit board techniques.

Thus, conventional RF tagging systems provide multiple different tuned (resonant) circuits on a tag so as to specifically identify the goods to which the tag is attached or the destination to which those goods should be directed.

In order to enhance the utility of such systems, RF tags having multiple resonant circuits have been developed to increase the number of possible different identification codes. Conventional systems utilizing multiple tuned circuit detection contemplate sequentially generating or gating each of the different resonant frequency signals to a transmitter antenna. Each different resonant frequency in a multiple frequency system may be provided by a master oscillator circuit or transmitter whose output is essentially swept or stepped to sequentially provide each desired output frequency. Then, reflected energy from each of the tuned circuits is detected. This feature results in very fast detection of which resonant frequency circuits are provided on a tag in a detection zone.

Alternatively, conventional RF tag identification codes may utilize a single resonant circuit on an RF tag which is resonant at a single frequency. When the identification code of the RF tag is read, a transmitter continually illuminates the tag with RF energy at the single frequency. Electronic circuitry on the tag selectively renders the resonant circuit reflective and non-reflective in accordance with a time function. A reader then monitors the reflected energy and decodes the time function to recover the tag identification code.

Various implementations of tags that provide ID codes may be provided. Therefore, any conventionally known technology for providing such tags would be of utility when used as part of or in conjunction with the invention embodiments.

With this information, any discrepancy between the number of tags removed and the number of articles on the receipt may indicate a need to perform additional investigation. It should be appreciated that, in some situations, delayed investigation may be acceptable; however, “real time” notification of discrepancies to store security may be implemented as a part of the system capability.

While this invention has been described in conjunction with the specific embodiments outlined above, it is evident that many alternatives, modifications and variations will be apparent to those skilled in the art. Accordingly, the various embodiments of the invention, as set forth above, are intended to be illustrative, not limiting. Various changes may be made without departing from the spirit and scope of the invention.

For example, various invention embodiments have been described wherein the security tag 155 is simply a mechanism for alerting a security system of the attempted theft of an article from store premises. However, in accordance with at least one embodiment of the invention, the security tag 155 may be configured to provide information about the article to which the tag 155 is attached. In such an implementation, when a customer arrives at the POS, the cashier may position the security tag 155 and article 105 so that the reader 210 (as illustrated in FIG. 2 can obtain article information (e.g., product identifier, UPC number, status information, etc.) from the security tag 155 (and/or article 105) and pass that information to the memory 260. In such an embodiment, the memory 260 may be accessible by the POS machine 220 and the POS machine 220 may “ring up” the sale; the POS machine 220 may then confirm the “ring-up” to the controller 220 and memory 260 and authorize the tag removal device 250 to release the security tag 155 from the article 105.

Additionally, it should be understood that the functionality described in connection with various described components of various invention embodiments may be combined or separated from one another in such a way that the architecture of the invention is somewhat different than what is expressly disclosed herein. Moreover, it should be understood that, unless otherwise specified, there is no essential requirement that methodology operations be performed in the illustrated order; therefore, one of ordinary skill in the art would recognize that some operations may be performed in one or more alternative order and/or simultaneously.

As a result, it will be apparent for those skilled in the art that the illustrative embodiments described are only examples and that various modifications can be made within the scope of the invention as defined in the appended claims.

1. A system for deterring theft of one or more articles, the system comprising:
a first reader configured to obtain data indicating an identity of an employee associated with a sales transaction;
a controller configured to coordinate the storage of the data indicating the employee identity and data associated with the sales transaction in a memory;
a tag removal device configured to remove one or more security tags under the direction of the controller;
wherein, the controller enables operation of the tag removal device following a determination of the number of security tags to be removed in connection with the sales transaction and storage of the employee identity, data indicating the number of tags removed in connection with the sales transaction.

2. The system of claim 1, further comprising a memory configured to store the employee identity and data indicating the number of tags removed in connection with the sales transaction.

3. The system of claim 1, wherein the first reader is an RFID reader.

4. The system of claim 1, further comprising a second reader configured to obtain data indicating the number of security tags to be removed in connection with the sales transaction.

5. The system of claim 1, wherein the tag removal device is further configured to identify a security tag ID associated with a security tag to be removed and to transmit the security tag ID to the controller to enable a determination whether the removed security tag corresponds to a security tag to be removed as part of the sales transaction.

6. The system of claim 1, wherein the controller receives information from a Point of Sale machine that processes the sales transaction.

7. The system of claim 6, wherein the Point of Sale machine generates a receipt corresponding to the sales transaction that includes a bar code that includes data indicating a number of security tagged items included in the sales transaction.

8. The system of claim 7, wherein the bar code also includes data indicating the security tag IDs for security tags affixed to articles included in the sales transaction.

9. The system of claim 1, wherein the security tags processed by the tag removal device are specifically configured so as not to be removable using tag removal devices of a type other than the type of tag removal device.

10. The system of claim 1, wherein the controller is further configured to disable the tag removal device following removal of the security tags associated with a sales transaction until receipt of data indicating the identity of an employee associated with a next sales transaction.

11. A method for deterring theft of one or more articles, the method comprising:
obtaining data indicating an identity of an employee associated with a sales transaction;
storing the data indicating the employee identity and data associated with the sales transaction in a memory;
removing one or more security tags using a tag removal device;
wherein, operation of the tag removal device is enabled following a determination of the number of security tags to be removed in connection with the sales transaction and storage of the employee identity, data indicating the number of tags removed in connection with the sales transaction.

12. The method of claim 10, further comprising storing the employee identity and data indicating the number of tags removed in connection with the sales transaction.

13. The method of claim 10, wherein the first reader is an RFID reader.

14. The method of claim 10, obtaining data indicating the number of security tags to be removed in connection with the sales transaction.

15. The method of claim 10, further comprising identifying a security tag ID associated with a security tag to be removed and transmitting the security tag ID to a controller to enable a determination whether the removed security tag corresponds to a security tag to be removed as part of the sales transaction.

16. The method of claim 10, further comprising receiving information from a Point of Sale machine that processes the sales transaction.

17. The method of claim 16, wherein the Point of Sale machine generates a receipt corresponding to the sales transaction that includes a bar code that includes data indicating a number of security tagged items included in the sales transaction and the method further comprises reading the bar code to determine the number of security tagged items included in the sales transaction.

18. The method of claim 17, wherein the bar code also includes data indicating the security tag IDs for security tags affixed to articles included in the sales transaction.

19. The method of claim 10, wherein the security tags processed by the tag removal device are specifically configured so as not to be removable using tag removal devices of a type other than the type of tag removal device.

20. The method of claim 10, further comprising disabling the tag removal device following removal of the security tags associated with a sales transaction until receipt of data indicating the identity of an employee associated with a next sales transaction.
